(19) United States
(12) Patent Application Publication
(10) Pub. No.: US 2023/0192135 A1
(43) Pub. Date: Jun. 22, 2023

(54) VEHICLE CONTROL APPARATUS

(71) Applicant: TOYOTA JIDOSHA KABUSHIKI KAISHA, Toyota-shi (JP)

(72) Inventor: Yusuke TANAKA, Toyota-shi (JP)

(73) Assignee: TOYOTA JIDOSHA KABUSHIKI KAISHA, Toyota-shi (JP)

(21) Appl. No.: 18/065,072

(22) Filed: Dec. 13, 2022

(30) Foreign Application Priority Data
Dec. 16, 2021 (JP) 2021-204035

(51) Int. Cl. B60W 60/00; B60W 30/18; B60W 50/14

(52) U.S. Cl. CPC B60W 60/0015; B60W 30/18; B60W 50/14; B60W 2554/4029; B60W 2540/229

(57) ABSTRACT

A vehicle control apparatus comprises a control unit that performs a traveling control, when a driver has fallen into an inappropriate state; and a notification device that performs a surround notification to notify a person around the vehicle of an execution of the traveling control. The control unit is configured to perform, as the traveling control, at least two of an in-lane stop control, a road shoulder stop control, and an autonomous driving control. When the driver has fallen into the inappropriate state, the control unit performs the traveling control that is selected based on a surrounding of the vehicle from among the above three controls, and causes the notification device to perform the surround notification in a mode that varies depending on the traveling control selected to be performed.

### TECHNICAL FIELD

The present disclosure relates to a vehicle control apparatus for performing a traveling (running) control when a driver has fallen into an inappropriate state for driving.

### BACKGROUND

There has been a known vehicle control apparatus configured to perform a traveling control when a driver has fallen into an inappropriate state for driving.

For example, a vehicle control apparatus (hereinafter, referred to as a “conventional apparatus”), disclosed in Japanese Patent Application Laid-Open No. 2021-96696, determines whether or not the driver is in a very sleepy state (i.e., whether a first state is occurring), and determines whether or not the vehicle is in a long hours driving state (i.e., whether a second state is occurring). When one of the first state and the second state is occurring, the conventional apparatus performs a state-notification to inform people outside of the vehicle of the state that is occurring, and execute the traveling control. The state-notification performed when the first state is occurring is differentiated from the state-notification performed when the second state is occurring.

The conventional apparatus controls the vehicle so as to stop the vehicle when the first state is occurring, and controls the vehicle so as to decelerate the vehicle when the second state is occurring. The conventional apparatus may perform an autonomous driving when the first state is occurring, and may perform a speed control in such a manner that a current speed of the vehicle does not exceed an upper limit speed when the second state is occurring. The conventional apparatus may control the vehicle so as to stop the vehicle at a road shoulder when the first state is occurring, and may control the vehicle in such a manner that the vehicle moves into a lane closest to the road shoulder when the second state is occurring.

### SUMMARY

As described above, the conventional apparatus changes the modes of the state-notification and the modes of the traveling control between the first state and the second state. However, there is a possibility that the conventional apparatus cannot perform the predetermined traveling control that should be changed in accordance with which one of the first state and the second state is occurring, because of a surrounding condition of the vehicle.

In view of the above, the present inventor(s) has been attempting to develop a vehicle control apparatus (hereinafter, referred to as an “apparatus under study”) that determines a traveling control to be performed depending on the surrounding (surrounding conditions) of the vehicle and performs the determined traveling control.

If the mode of the state-notification for the first state and the mode of the state-notification for the second state have been determined in advance as in the conventional apparatus, the apparatus under study may perform the state-notification in the different modes even when the apparatus performs the same traveling control. This may cause people outside of the vehicle to be unable to take an appropriate action for the vehicle, since they cannot specify what/which traveling control is being performed.

The present disclosure is made to cope with the problem described above. That is, one of objectives of the present disclosure is to provide a vehicle control apparatus configured to determine a traveling control to be performed in accordance with a surrounding of a vehicle, and be capable of cause people outside the vehicle to specify/recognize the traveling control that is being performed so as to increase a possibility that they take an appropriate action (make a move) for the vehicle.

The vehicle control apparatus (hereinafter, referred to as a “present disclosure apparatus”) comprises:

a control unit (20, 30, 40, 50) that performs a traveling control regarding a travel of a vehicle, when a driver of the vehicle has fallen into an inappropriate state where a condition/state of the driver is not appropriate for driving the vehicle; and

a notification device (66, 72, 74) that performs a surround notification to notify a person around (outside of) the vehicle of an execution of the traveling control when the traveling control is performed,

wherein, the control unit is configured to:
be able to perform, as the traveling control, at least two of an in-lane stop control to stop the vehicle in a traveling lane in which the vehicle is traveling, a road shoulder stop control to stop the vehicle on a road shoulder of a road that includes the traveling lane, and an autonomous driving control to autonomously drive the vehicle to a predetermined destination;
perform the traveling control that is selected based on a surrounding of the vehicle from among the in-lane stop control, the road shoulder stop control, and the autonomous driving control, when the driver has fallen into the inappropriate state (step 545, step 600 to step 695, step 915, step 930, step 945); and
cause the notification device to perform the surround notification in a mode that varies depending on the traveling control selected to be performed (step 920, step 935).

According to the present disclosure apparatus, since the surround notification is performed in a mode varying depending on the traveling control that is being executed, people outside of the vehicle can easily specify (recognize/tell) the traveling control that is being executed. Therefore, the present disclosure apparatus can increase a possibility that the people outside of the vehicle can take an appropriate action for the traveling control that is being executed.

In some embodiments, the control unit is configured to:
be able to perform at least one of the road shoulder stop control and the autonomous driving control; and
start causing the notification device to perform the surround notification before the vehicle deviates from the traveling lane due to a course change of the vehicle, when performing one of the road shoulder stop control and the autonomous driving control (step 820, step 845).

According to the above embodiment, since the surround notification is started before the vehicle deviates/departs from the traveling lane, it is possible to inform people outside of the vehicle of a possibility that the vehicle VA deviates from the traveling lane with certainty.

In some embodiments, the control unit is configured to:
be able to perform the autonomous driving control;
be able to perform at least one of the in-lane stop control and the road shoulder stop control,

wherein, the notification device includes a specific notification device (74) that performs the surround notification of when the autonomous driving control is performed,

and wherein,

the control unit is configured to:
cause the specific notification device to perform the surround notification of when the autonomous driving control is performed, when performing the autonomous driving control (step 920), so that a mode of the surround notification of when the autonomous driving control is performed is different from a mode of the surround notification of when the in-lane stop control or the road shoulder stop control is performed.

When the in-lane stop control or the road shoulder stop control is performed, the vehicle is decelerated so as to stop. Whereas, when the autonomous driving control is performed, the vehicle is not necessarily decelerated. Therefore, there is a case where it is not appropriate for an other vehicle behind the vehicle to overtake or pass the vehicle. According to the above embodiment, the specific notification device performs the surround notification when the autonomous driving control is performed, unlike a case where the in-lane stop control or the road shoulder stop control is performed. This can increase a possibility that people around the vehicle can specify (tell) that the autonomous driving control is performed. Thus, it is possible to increase a possibility that people outside of the vehicle can take an appropriate action for the traveling control that is being executed.

In some embodiment, the present disclosure apparatus comprises:

a control unit (20, 30, 40, 50) that performs a traveling control regarding a travel of a vehicle, when a driver of the vehicle has fallen into an inappropriate state where a condition of the driver is not appropriate for driving the vehicle; and

a notification device (66, 72, 74) that performs a surround notification to notify a person outside of the vehicle of an execution of the traveling control when the traveling control is performed,

wherein, the control unit is configured to:
perform, as the traveling control, one of an in-lane stop control to stop the vehicle in a traveling lane in which the vehicle is traveling, a road shoulder stop control to stop the vehicle on a road shoulder of a road that includes the traveling lane, and an autonomous driving control to autonomously drive the vehicle to a predetermined destination, depending on a surrounding of the vehicle, when the driver has fallen into the inappropriate state (step 545, step 600 to step 695, step 915, step 930, step 945); and
differentiate a mode of the surround notification of when the autonomous driving control is performed from a mode of the surround notification of when the in-lane stop control or the road shoulder stop control is performed (step 920, step 935).

In the embodiment described above, since the mode of the surround notification of when the autonomous driving control is performed is different from the mode of the surround notification of when the in-lane stop control or the road shoulder stop control is performed, it is possible to increase a possibility that people around the vehicle can specify (tell) whether the autonomous driving control is being performed. Thus, it is possible to increase a possibility that people outside of the vehicle can take an appropriate action for the traveling control that is being executed.

Notably, in the above description, in order to facilitate understanding of the present disclosure, the constituent elements or the like of the disclosure corresponding to those of the embodiments of the disclosure which will be described later are accompanied by parenthesized names and/or symbols which are used in the embodiments. However, the constituent elements of the disclosure should not be limited to those in the embodiments defined by the names and/or the symbols. Other objects, other features, and attendant advantages of the present disclosure will be readily appreciated from the following description of the embodiment of the disclosure which is made with reference to the accompanying drawings.

### BRIEF DESCRIPTION OF THE DRAWINGS

FIG. 1 is a schematic diagram of a vehicle control apparatus according to an embodiment of the present disclosure.

FIG. 2 is a drawing for describing operation of the vehicle control apparatus when performing an autonomous driving control.

FIG. 3 is a drawing for describing operation of the vehicle control apparatus when performing a road shoulder stop control.

FIG. 4 is a drawing for describing operation of the vehicle control apparatus when performing an in-lane stop control.

FIG. 5 is a flowchart illustrating an inappropriate state determining routine executed by a CPU of a vehicle control ECU shown in FIG. 1.

FIG. 6 is a flowchart illustrating a traveling control determination subroutine executed by the CPU of the vehicle control ECU shown in FIG. 1.

FIG. 7 is a flowchart illustrating a return determination routine executed by the CPU of the vehicle control ECU shown in FIG. 1.

FIG. 8 is a flowchart illustrating a traveling control before final determination routine executed by the CPU of the vehicle control ECU shown in FIG. 1.

FIG. 9 is a flowchart illustrating a traveling control after final determination routine executed by the CPU of the vehicle control ECU shown in FIG. 1.

### DETAILED DESCRIPTION

### <Configuration>

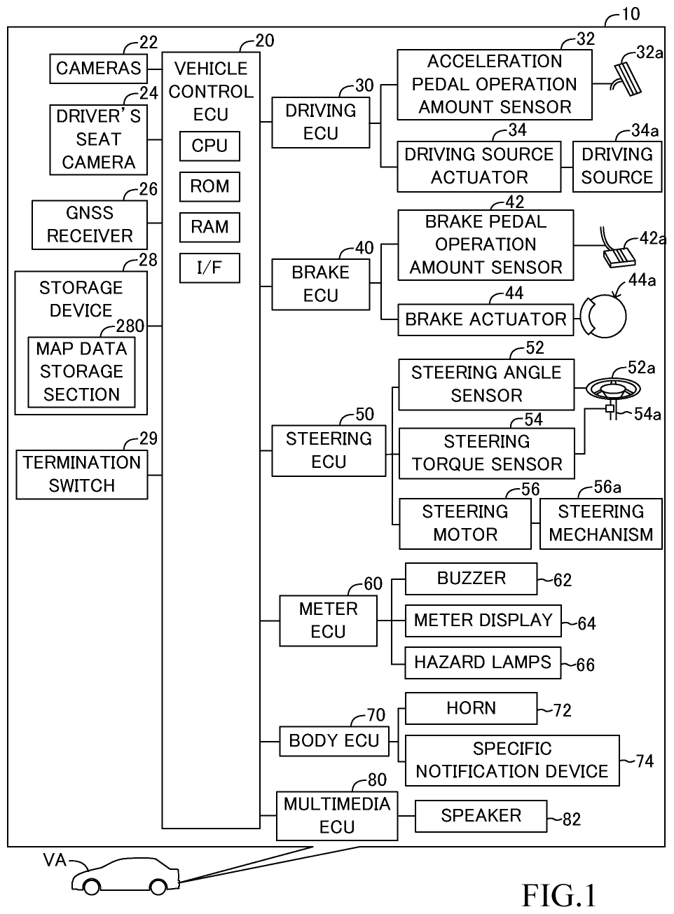

As shown in FIG. 1, a vehicle control apparatus (hereinafter, referred to as a “present control apparatus”) 10 according to an embodiment of the present disclosure is applied to (or installed in) a vehicle VA. The present control apparatus 10 comprises a vehicle control ECU (hereinafter, referred to as a “VCECU”) 20, a driving ECU 30, a brake ECU 40, a steering ECU 50, a meter ECU 60, a body ECU 70, and a multimedia ECU 80. These ECUs 20, 40, 50, 60, 70, and 80 are communicably connected with each other so as to be able to mutually exchange data through a CAN (Controller Area Network).

An “ECU” is an abbreviation of an “Electronic Control Unit” that is an electronic control circuit including a microcomputer as a main component. The microcomputer includes a CPU, a ROM, a RAM, and an interface (I/F). The ECU may sometimes be referred to as a “control unit” or a “controller”. The CPU is configured and/or programmed to realize various functions by executing instructions (routines) stored in a memory (the ROM). Some or all of the ECUs 20, 30, 40, 50, 60, 70, and 80 may be integrated into a single ECU.

The present control apparatus 10 comprises a plurality of cameras 22, a driver's seat camera 24, a GNSS (Global Navigation Satellite System) receiver 26, and a storage device 28. These (22-28) are communicably connected with the VCECU 20 so as to be able to mutually exchange data.

A plurality of the cameras 22 includes a front direction camera, a rear direction camera, a left side direction camera, and a right side direction camera. Each of the cameras 22 captures (takes) an image of an area described below so as to produce outside image data, and send the outside image data to the VCECU 20, every time a predetermined time elapses. The front direction camera, the rear direction camera, the left side direction camera, and the right side direction camera capture an image of a frontward area of the vehicle VA, an image of a rearward area of the vehicle VA, an image of a leftward area of the vehicle VA, and an image of a rightward area of the vehicle VA, respectively.

The driver's seat camera 24 captures/takes an image of an area in the vicinity of a face of a driver sitting in a driver's seat of the vehicle VA so as to produce face image data, and send the face image data to the VCECU 20, every time a predetermined time elapses.

The GNSS receiver 26 is a device that receives a positioning signal transmitted from global positioning satellites. The VCECU 20 obtains (specifies) a present position (expressed by longitude and latitude) of the vehicle VA based on the positioning signals received by the GNSS receiver 26.

The storage device 28 is a non-volatile memory device that the VCECU 20 can read data from and write data into. For example, the storage device 28 is a hard disc drive. However, the storage device 28 is not limited to the hard disc drive, but may be a well known readable and writable storage device or storage medium. The storage device 28 includes map data storage section 280 storing high precision (fine) map data used for a traveling/running control described later.

In addition, the VCECU 20 is connected with a termination (cancel) switch 29. The termination switch 29 is disposed in the vicinity of a steering wheel 52a of the vehicle VA, and is operated by the driver or an occupant of the vehicle VA when he/she wants to terminate the traveling control described later.

The driving ECU 30 is connected with an acceleration pedal operation amount sensor 32 and a driving source actuator 34 so as to be able to mutually exchange data with them.

The acceleration pedal operation amount sensor 32 is configured to detect an acceleration pedal operation amount AP that is an operation amount of an acceleration pedal 32a, and to generate a signal indicative of the acceleration pedal operation amount AP. The driving ECU 30 obtains the acceleration pedal operation amount AP based on the signal generated by the acceleration pedal operation amount sensor 32.

The driving source actuator 34 is connected with a driving source (a motor, an internal combustion engine, or the like) 34a that generates a driving force applied to the vehicle VA. The driving source 34a may sometimes be referred to as a “driving device”. The driving ECU 30 controls the driving source actuator 34 so as to change a driving state of the driving source 34a. Therefore, the driving ECU 30 can adjust the driving force applied to the vehicle VA. The driving ECU 30 drives the driving source actuator 34 in such a manner that the driving force applied to the vehicle VA becomes greater as the acceleration pedal operation amount AP becomes greater. In addition, when the driving ECU 30 receives an acceleration-deceleration instruction including a target acceleration Gtgt from the VCECU 20, the driving ECU 30 drives the driving source actuator 34 in such a manner that an acceleration G of the vehicle VA becomes equal to (coincides with) the target acceleration Gtgt.

The brake ECU 40 is connected with a brake pedal operation amount sensor 42, and a brake actuator 44, so as to be able to mutually exchange data with them.

The brake pedal operation amount sensor 42 is configured to detect a brake pedal operation amount BP that is an operation amount of a brake pedal 34a, and to generate a signal indicative of the brake pedal operation amount BP. The brake ECU 40 obtains the brake pedal operation amount BP based on the signal generated by the brake pedal operation amount sensor 42.

The brake actuator 44 is connected with a well-known hydraulic brake device 44a. The brake ECU 40 controls the brake actuator 44 so as to change a frictional brake force that the brake device 44a generates. Therefore, the brake ECU 40 can adjust a brake force applied to the vehicle VA. The brake ECU 40 drives the brake actuator 44 in such a manner that the brake force applied to the vehicle VA becomes greater as the brake pedal operation amount BP becomes greater. In addition, when the brake ECU 40 receives the acceleration-deceleration instruction including from the VCECU 20, the brake ECU 40 drives the brake actuator 44 in such a manner that the acceleration G of the vehicle VA becomes equal to (coincides with) the target acceleration Gtgt.

The steering ECU 50 is connected with a steering angle sensor 52, a steering torque sensor 54, and a steering motor 56.

The steering angle sensor 52 is configured to detect, as a steering angle θs, a rotating angle of the steering wheel 52a from a neutral position so as to generate a signal indicative of the steering angle θs. The steering ECU 50 obtains the steering angle θs based on the signal generated by the steering angle sensor 52.

The steering torque sensor 54 is configured to detect a steering torque Tr acting on a steering shaft 54a connected to the steering wheel 52a so as to generate a signal indicative of the steering torque Tr. The steering ECU 50 obtains the steering torque Tr based on the signal generated by the steering torque sensor 54.

The steering motor 56 generates a torque in accordance with an electric power provided from an unillustrated vehicle battery. The steering ECU 50 controls a magnitude and a direction of the electric power supplied to the steering motor 56. The steering motor 56 is incorporated into and is capable of transmitting the torque to a steering mechanism 56a of the vehicle VA. The steering mechanism 56a includes the steering wheel 52a, the steering shaft 54a, and a steering gear mechanism. The torque generated by the steering motor 56 generates a steering assist torque. A right steered wheel and a left steered wheel are steered by the steering assist torque.

The steering ECU 50 is configured to let the steering motor 56 generate the steering assist torque in accordance with the steering torque Tr in a normal driving state. In addition, when the steering ECU 50 receives “a steering instruction including a target steering angle” from the VCECU 20, the steering ECU 50 controls the steering motor 56 in such a manner that the steering angle θs becomes equal to (coincides with) the “target steering angle included in the received steering instruction” so as to automatically steer the steered wheels.

The meter ECU 60 is connected with a buzzer 62, a meter display 64, and hazard lamps 66, so as to be able to mutually exchange data with them. The buzzer 62 generates an alert (warning) sound in accordance with an output instruction from the meter ECU 60. The meter display 64 displays a speed meter, an odometer, a tachometer, and a fuel meter. The hazard lamps 66 are disposed at a left and a right of the front end of the vehicle VA, and at a left and a right of the rear end of the vehicle VA. When an unillustrated hazard switch is operated, all of the hazard lamps 66 blink. When an unillustrated turn signal lever is operated, only of the hazard lamps 66 corresponding to the operated direction of the turn signal lever blink. For example, when the operated direction of the turn signal lever is upward, only of the hazard lamps 66 located at the left side of the vehicle VA blink. When the operated direction of the turn signal lever is downward, only of the hazard lamps 66 located at the right side of the vehicle VA blink.

The body ECU 70 is connected with a horn 72 and a specific notification device 74, so as to be able to mutually exchange data with them. The horn 72 generates an alarm sound to outside of the vehicle VA. The specific notification device 74 is disposed in a vehicle compartment at a position that can be easily observed (seen) from the outside of the vehicle VA. For example, the specific notification device 74 is a light.

The multimedia ECU 80 is connected with a speaker 82 so as to be able to mutually exchange data with it. The speaker 82 generates sounds to inside of the vehicle VA in accordance with an instruction from the multimedia ECU 80.

### (Outline of Operation)

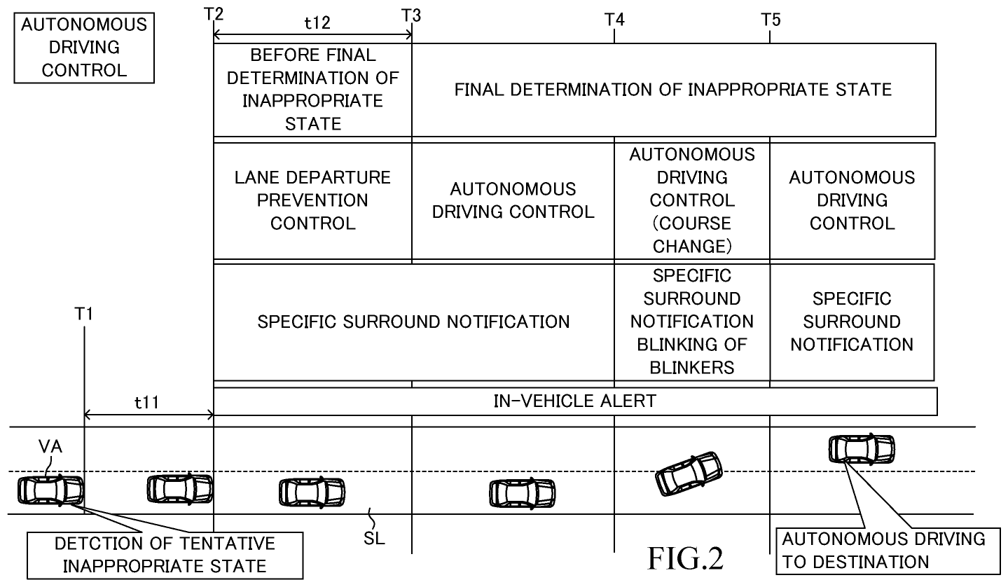

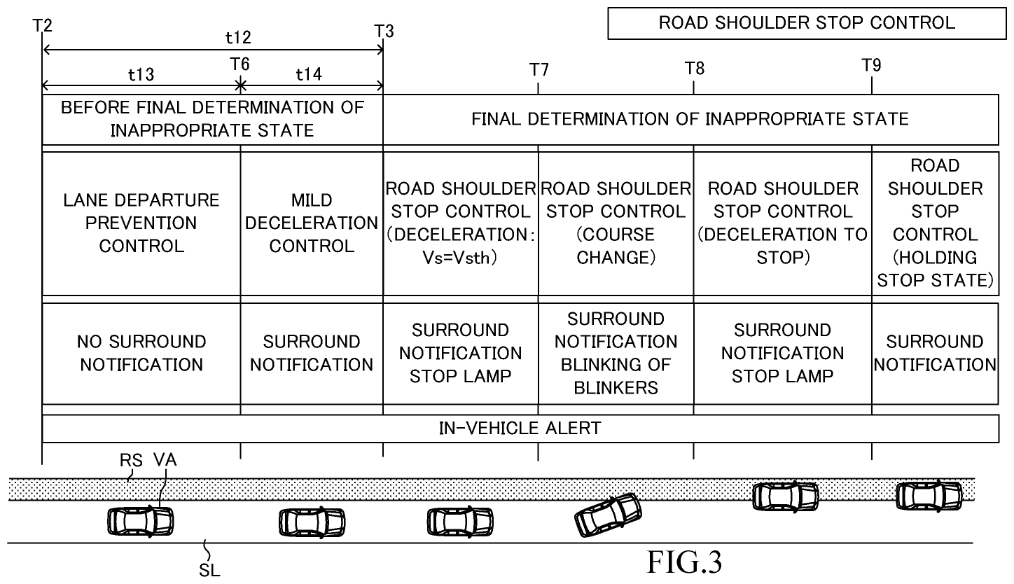

The present control apparatus 10 determines whether or not the driver of the vehicle VA has fallen into an inappropriate state that is a state where the driver is inappropriate for driving the vehicle VA. When it is determined that the driver has fallen into the inappropriate state, the present control apparatus 10 performs one of three traveling controls described below, in accordance with (depending on) the surrounding (surrounding conditions) of the vehicle VA.
An autonomous driving control: a control to cause the vehicle VA to travel/run automatically/autonomously to a predetermined destination without requiring any driving operation by the driver.
A road shoulder stop control: a control to cause the vehicle VA to move to a road shoulder RS (refer to FIG. 3) in the vicinity of a traveling lane SL (refer to FIGS. 2-4) in which the vehicle VA is currently traveling/running, and to cause the vehicle VA to stop at (in) the road shoulder.
A in-lane stop control: a control to cause the vehicle VA to stop in the traveling lane SL.

When the present control apparatus 10 is performing one of the above-described traveling controls after the driver has fallen into the inappropriate state, the present control apparatus 10 performs a surround notification to notify people outside of the vehicle VA that the one of the above-described traveling controls is being performed. The present control apparatus 10 performs the surround notification in a first mode, when the autonomous driving control is being executed. The present control apparatus 10 performs the surround notification in a second mode different from the first mode, when one of the road shoulder stop control and the in-lane stop control is being executed.

More specifically, when the present control apparatus 10 is executing one of the road shoulder stop control and the in-lane stop control, the present control apparatus 10 performs the surround notification in the second mode so as to blink the hazard lamps 66 and generate alert sound from the horn 72. Whereas, when the present control apparatus 10 is executing the autonomous driving control, the present control apparatus 10 performs the “surround notification in the first mode” that is referred to as a specific surround notification so as not only to blink the hazard lamps 66 and generate alert sound from the horn 72 but also to perform a notification using the specific notification device 74 by causing the specific notification device 74 to emit light (operate). It should be noted that each of the hazard lamps 66, the horn 72, and the specific notification device 74 is referred to a “notification device”.

While the vehicle VA is traveling according to the road shoulder stop control or the in-lane stop control, the vehicle VA decelerates. Therefore, other vehicles behind the vehicle VA tend to overtake or pass the vehicle VA. Whereas, while the vehicle VA is traveling according to the autonomous driving control, the vehicle VA does not necessarily decelerate. Therefore, there is a case where it is not appropriate for the other vehicles behind the vehicle VA to overtake or pass the vehicle VA.

The present control apparatus 10 allows people outside of the vehicle VA to specify (tell) whether the vehicle is traveling according to the autonomous driving control or is traveling according to one of the road shoulder stop control and the in-lane stop control. This can reduce the possibility that the other vehicle behind the vehicle VA overtakes or attempts to overtake the vehicle VA that is traveling according to the autonomous driving control, and therefore, the present control apparatus 10 can increase a possibility that the people outside of the vehicle VA takes an appropriate action for the vehicle VA.

### (Examples of Operation)

Examples of operation of the present control apparatus 10 will next be described with reference to FIGS. 2-4.

### <Autonomous Driving Control>

Firstly, an example of operations of the present control apparatus 10 when the present control apparatus 10 executes the autonomous driving control is described with reference to FIG. 2.

At a time point T1, the present control apparatus 10 detects/determines that the driver has fallen into a tentative inappropriate state. For example, the present control apparatus 10 determines, based on the face image data, that the driver has fallen into the tentative inappropriate state, when one of following states is detected.
A looking aside state: a state where the driver does not look ahead (forward).
An eyes closed state: a state where the driver closes his/her eyes.
An inappropriate driving posture state: a state where a driving posture of the driver is inappropriate for driving.
A head lost state: a state where a head of the driver is not detected based on the face image data.
A drowsy state: a state where the driver feels sleepy/drowsy.

The present control apparatus 10 determines that it is likely that the driver has fallen into the inappropriate state, when the tentative inappropriate state of the driver continues for a predetermined time t11 from the time point T1. Note that, at this time point, the present control apparatus 10 has not determined that the driver has fallen into the inappropriate state. At a time point T2 at which the predetermined time t11 elapses from the time point T1, the present control apparatus 10 determines the traveling control to be executed based on the surrounding of the vehicle VA in a case where there is no abnormality (e.g., a failure in the brake device 44, or a failure in the steering mechanism 56a) that causes the vehicle VA to be unable to travel under one of the traveling controls. More specifically, at the time point T2, the present control apparatus 10 determines whether or not an autonomous driving condition is satisfied.

The present control apparatus 10 determines that the autonomous driving condition is satisfied, when the present control apparatus 10 determines that an other vehicle is not cutting in, into the traveling lane SL, based on the outside image data, and when map data within a predetermined area around a present position of the vehicle VA has been stored in the map data storage section 280. It should be noted that the present position of the vehicle VA is specified based on the positioning signal received by the GNSS receiver 26.

In the example shown in FIG. 2, it is assumed that the autonomous driving condition is satisfied at the time point T2. In this case, at the time point T2. the present control apparatus 10 determines the autonomous driving control as the traveling control to be executed. At the time point T2, the present control apparatus 10 starts (executing) a lane departure prevention control, the above-described specific surround notification, and an in-vehicle alert.

As the lane departure prevention control, the present control apparatus 10 controls the steering motor 56 in such a manner that the vehicle VA does not depart from the traveling lane.

The present control apparatus 10, as the in-vehicle alert, displays a message stating “Watch the surrounding of the vehicle VA” on the meter display 64 and generates a voice sound stating “Watch the surrounding of the vehicle VA” from the speaker 82. Note that, in addition to or instead of these, the present control apparatus 10 may generate an alert sound from the buzzer 62, as the in-vehicle alert,

If the tentative inappropriate state still continues in a period from the time point T2 to a time point T3 at which a predetermined time t12 elapses from the time point T2, the present control apparatus 10 finally determines (makes a final determination) that the driver has fallen into the inappropriate state at the time point T3. In this case, at the time point T3, the present control apparatus 10 starts (executing) the autonomous driving control. More specifically, the present control apparatus 10 obtains a traveling route from the present position of the vehicle VA to the predetermined destination based on the map data, and causes the vehicle VA to autonomously travel along the traveling route. The destination is, for example, a closest hospital, a service area, a rest area, or a closest exit of a highway.

The present control apparatus 10 causes the vehicle VA to change lanes when changing lanes becomes necessary while executing the autonomous driving control based on the traveling route. In the example shown in FIG. 2, the present control apparatus 10 causes the vehicle VA to change lanes in a period from a time point T4 to a time point T5. In this period, the present control apparatus 10 blinks only of the hazard lamps 66 located in the lane change side, and continues generating the sound from the horn 72 and operating the specific notification device 74.

As described, the specific surround notification is started at the time point T2. Thus, the specific surround notification is started before the vehicle VA departs from the traveling lane SL due to the lane change under the autonomous driving control. This enables people outside of the vehicle VA to perceive that there is a probability that the vehicle VA departs from the traveling lane SL, before the vehicle VA actually departs from the traveling lane SL.

When the vehicle VA reaches the destination, the present control apparatus 10 decelerates the vehicle VA so as to stop the vehicle VA. After vehicle VA stops, the present control apparatus 10 activates an unillustrated parking brake actuator and moves a shift position to a parking position. This causes the vehicle VA to continue being stopped.

The present control apparatus 10 continues (executing) the specific surround notification and the in-vehicle alert until a return condition described below becomes satisfied, after the vehicle VA stops.

The return condition becomes satisfied, when at least one of the following three conditions becomes satisfied.
A condition to be satisfied when it can be determined, based on the face image data, that the driver has returned to a normal state (appropriate state for driving).
A condition to be satisfied when the steering wheel 52a is operated.
A condition to be satisfied when the termination switch 29 is operated.

### <Road Shoulder Stop Control>

An example of operations of the present control apparatus 10 when the present control apparatus 10 executes the road shoulder stop control is described with reference to FIG. 3.

At a time point T2 shown in FIG. 3, it is assumed that the autonomous driving condition is not satisfied. In this case, the present control apparatus 10 determines whether or not a road shoulder stop condition is satisfied. The present control apparatus 10 determines that the road shoulder stop condition is satisfied, when the present control apparatus 10 determines that the the road shoulder RS to which the vehicle VA can safely move exists (or is present) based on the outside image data. The road shoulder RS to which the vehicle VA can safely move is a road shoulder RS, which is away from the present position of the vehicle VA in the traveling direction of the vehicle VA by a predetermined distance, and to which no obstacle is present in a path that leads.

In the example shown in FIG. 3, it is assumed that the road shoulder stop condition is satisfied. In this case, the present control apparatus 10 determines the road shoulder stop control is a control to be executed as the traveling control. At the time point T2 shown in FIG. 3, the present control apparatus 10 starts (executing) the lane departure prevention control and the in-vehicle alert.

At a time point T6 at which “a predetermined period t13 shorter than the predetermined time t12” elapses from the time point T2 shown in FIG. 3, the present control apparatus 10 starts executing a mild deceleration control to decelerate the vehicle VA at a predetermined negative acceleration G1tgt, and starts performing the surround notification.

At a time point T3, shown in FIG. 3, at which a predetermined time t14 elapses from the time point T6 (i.e., at the time point T3 at which the predetermined time t12 elapses from the time point T2 shown in FIG. 3), the present control apparatus 10 finally determines (makes a final determination) that the driver has fallen into the inappropriate state so as to start (executing) the road shoulder stop control. Note that the predetermined time t14 is set to a time obtained by subtracting the predetermined time t13 from the predetermined time t12.

When and after starting the road shoulder stop control, the present control apparatus 10 determines a target position on the road shoulder RS where the vehicle can be stopped (evacuated), based on a vehicle speed Vs and the outside image data. Thereafter, the present control apparatus 10 determines/produces a traveling path (route) that causes the vehicle VA to stop at the target position. In addition, at the time point T3 at which the present control apparatus 10 starts executing the road shoulder stop control, the present control apparatus 10 starts executing a deceleration control to cause the vehicle VA to decelerate at a predetermined negative acceleration G2tgt until the vehicle speed Vs becomes equal to a predetermined speed threshold Vsth (e.g., 10 km/h), and starts turning on unillustrated stop lamps. The acceleration G2tgt has been set to a value smaller than the acceleration G1tgt.

At a time point T7 at which the vehicle speed Vs becomes equal to the predetermined speed threshold Vsth, the present control apparatus 10 starts causing the vehicle VA to change course for/toward the road shoulder RS along the traveling path. In this case, the present control apparatus 10 blinks only of the hazard lamps 66 located in the change course side of the vehicle VA, and continues generating the sound from the horn 72.

As described, the surround notification is started at the time point T6. Thus, the surround notification is started before the vehicle VA departs from the traveling lane SL due to the course change under the road shoulder stop control. This enables people outside of the vehicle VA to perceive that there is a probability that the vehicle VA departs from the traveling lane SL, before the vehicle VA actually departs from the traveling lane SL.

When the course change has been completed at a time point T8, the present control apparatus 10 starts executing a stop deceleration control to decelerate the vehicle VA at the above-described acceleration G2tgt until the vehicle VA stops. In this case, the present control apparatus 10 performs the surround notification to blinks both sides of the hazard lamps 66, and continues generating the sound from the horn 72.

At a time point T9 at which the vehicle VA stops, the present control apparatus 10 activates the unillustrated parking brake actuator and moves the shift position to the parking position so as to cause the vehicle VA to continue being stopped. In this case as well, the surround notification is continued.

### <In-Lane Stop Control>

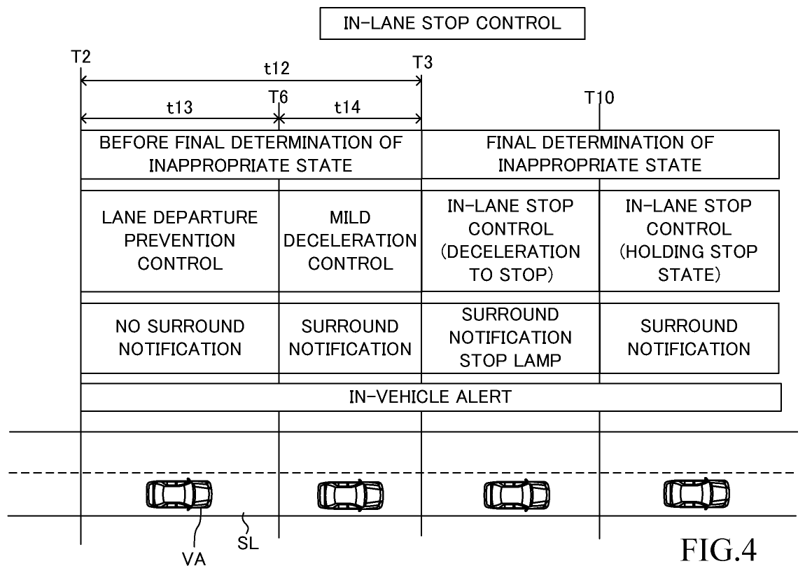

An example of operations of the present control apparatus 10 when the present control apparatus 10 executes the in-lane stop control is described with reference to FIG. 4.

At a time point T2 shown in FIG. 4, it is assumed that neither the autonomous driving condition nor the road shoulder stop condition is satisfied. In this case, the present control apparatus 10 determines the in-lane stop control to be executed as the traveling control. In this case, similarly to the case where the present control apparatus 10 executes the road shoulder stop control, the present control apparatus 10 executes the lane departure prevention control in a period from the time point T2 shown in FIG. 4 to a time point t6 shown in FIG. 4. In addition, the present control apparatus 10 starts executing the mild deceleration control and the surround notification, at a time point T7 shown in FIG. 4.

At a time point T3, shown in FIG. 4, at which the present control apparatus 10 finally determines (makes a final determination) that the driver has fallen into the inappropriate state, the present control apparatus 10 starts (executing) the in-lane stop control. More specifically, at the time point T3 shown in FIG. 4, the present control apparatus 10 starts (executing) the above-described stop deceleration control, and starts turning on the stop lamps in addition to the surround notification.

At a time point T10 at which the vehicle VA stops, the present control apparatus 10 activates the unillustrated parking brake actuator and moves the shift position to the parking position so as to cause the vehicle VA to continue being stopped. In this case as well, the surround notification is continued.

### (Specific Operation)

### <Inappropriate State Determining Routine>

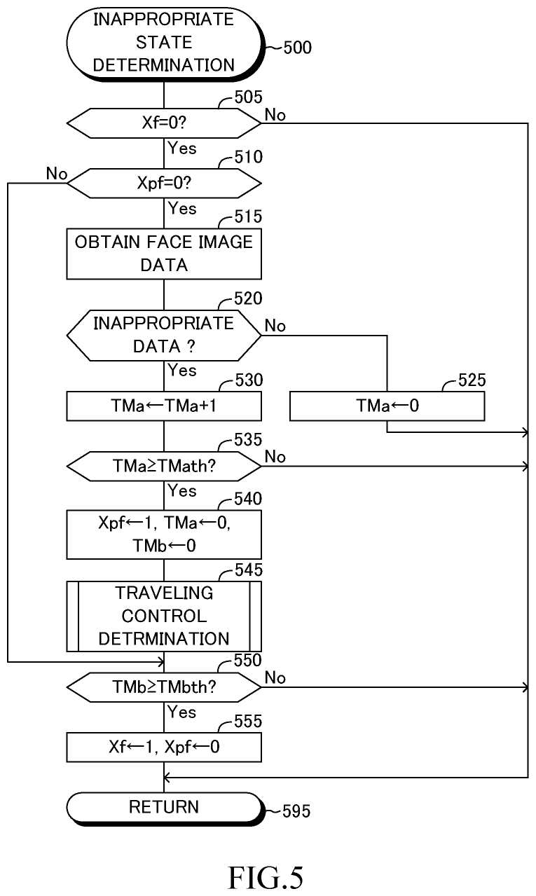

The CPU of the VCECU 20 (hereinafter, the “CPU” means the CPU of the VCECU 20 unless otherwise specified) is configured or programmed to execute an inappropriate state determining routine shown by a flowchart in FIG. 5 every time a predetermined time elapses.

When an appropriate time point comes, the CPU starts processing from step 500 in FIG. 5, and proceeds to step 505. At step 505, the CPU determines whether or not a value of a post determination flag Xf is “0”.

The value of the post determination flag Xf is set to “1” when a determination that the driver has fallen into the inappropriate state is confirmed (finalized), and is set to “0” when the return condition becomes satisfied.

When the value of the post determination flag Xf is “0”, the CPU makes a “Yes” determination at step 505, and proceeds step 510. At step 510, the CPU determines whether or not a value of a tentative determination flag Xpf is “0”.

The value of the tentative determination flag Xpf is set to “1” when it is detected a state in which the driver is in the tentative inappropriate state has continued for the predetermined time t11, and is set to “0” when the return condition becomes satisfied.

When the value of the tentative determination flag Xpf is “0”, the CPU makes a “Yes” determination at step 510, and sequentially executes the processes of step 515 and step 520.

Step 515: the CPU obtains the face image data from the driver's seat camera 24.

Step 520: the CPU determines whether or not the driver is in the tentative inappropriate state based on the face image data.

When the driver is not in the tentative inappropriate state, the CPU makes a “No” determination at step 520, and proceeds to step 525. At step 525, the CPU sets a value of a first timer TMa to “0”. Thereafter, the CPU proceeds to step 595 to terminate the present routine tentatively. The first timer TMa is a timer for measuring a time (time length) of a state in which the driver is in the tentative inappropriate state.

If the the driver is in the tentative inappropriate state when the CPU proceeds to step 520. the CPU makes a “Yes” determination at step 520, and sequentially executes the processes of step 530 and step 535.

Step 530: the CPU increments the value of the first timer TMa by “1”.

Step 535: the CPU determines whether or not the value of the first timer TMa is equal to or greater than a predetermined first timer threshold TMath.

The first timer threshold TMath has been set to a value that the first timer TMa reaches, when the tentative inappropriate state continues for the predetermined time t11.

When the value of the first timer TMa is smaller than the first timer threshold TMath, the CPU makes a “No” determination at step 535, and proceeds to step 595 to terminate the present routine tentatively.

Whereas, when the value of the first timer TMa is equal to or greater than the first timer threshold TMath, the CPU determines that it is likely (or there is a high possibility that) the driver has fallen into the inappropriate state. In this case, the CPU makes a “Yes” determination at step 535, and sequentially executes the processes of step 540 to step 550.

Step 540: the CPU sets the value of the tentative determination flag Xpf to “1”, sets the value of the first timer TMa to “0”, and sets a value of a second timer TMb to “0”.

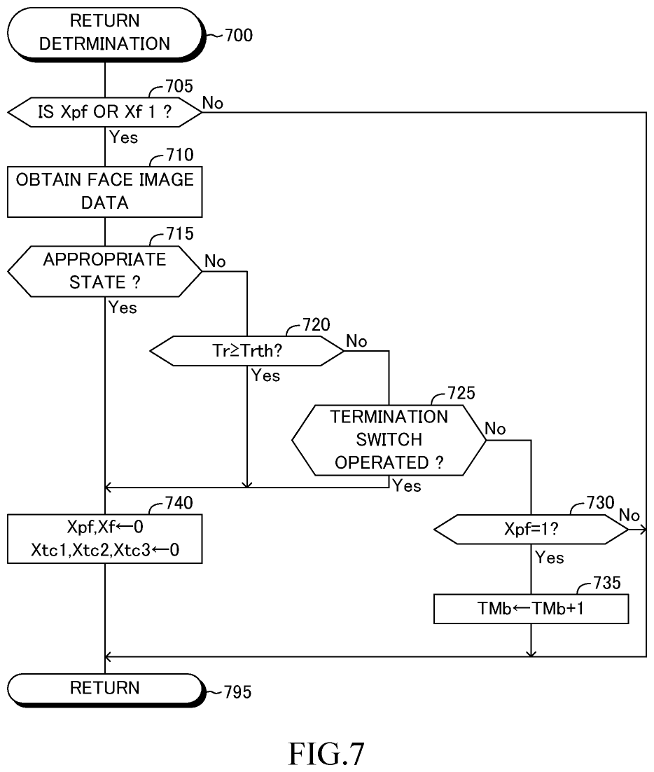

The second timer TMb is a timer for measuring an elapsed time (time length) from the time point at which it is determined that it is likely (or there is a high possibility that) the driver has fallen into the inappropriate state (i.e., a timer for measuring a time length of the state where it is determined that it is likely the driver has fallen into the inappropriate state). It should be noted that the CPU increments the value of the second timer TMb by “1” when the CPU determines that the return condition is not satisfied in a return determination routine shown in FIG. 7 (refer to step 735 shown in FIG. 7).

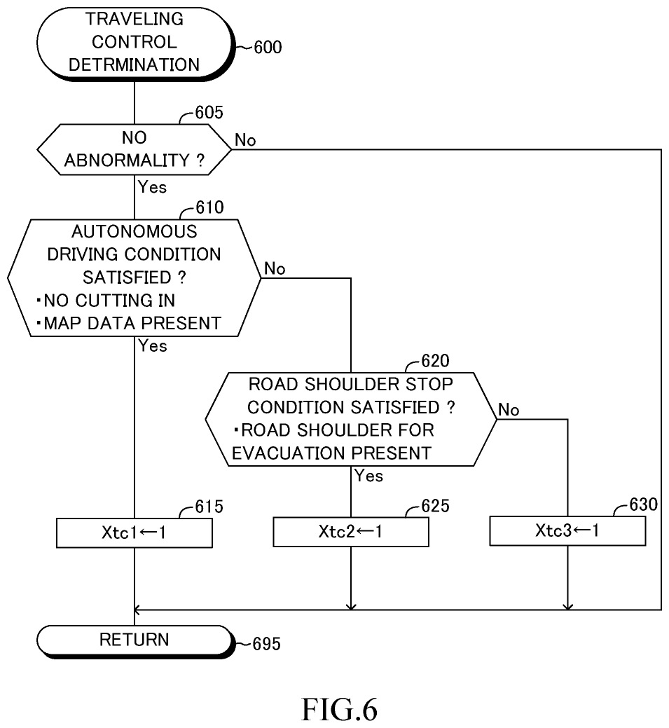

Step 545: the CPU executes a traveling control determination subroutine. In actuality, when the CPU proceeds to step 545, the CPU executes a subroutine shown by a flowchart in FIG. 6. In the subroutine, the CPU determines the traveling control to be performed, based on the surrounding of the vehicle VA.

Step 550: the CPU determines whether or not the value of the second timer TMb is equal to or greater than a predetermined second timer threshold TMbth.

The second timer threshold TMbth has been set to a value that the second timer TMb reaches, when the predetermined time t12 elapses from the time point at which the value of the tentative determination flag Xpf is set to “1”.

When the value of the second timer TMb is smaller than the second timer threshold TMbth, the CPU makes a “No” determination at step 550, and proceeds to step 595 to terminate the present routine tentatively.

If the value of the tentative determination flag Xpf is “1” when the CPU proceeds to step 510, the CPU makes a “No” determination at step 510, and directly proceeds to step 550. In this case, the CPU makes a “Yes” determination at step 550 and proceeds to step 555, if the value of the second timer TMb is equal to or greater than the second timer threshold TMbth.

At step 555, the CPU sets the value of the post determination flag Xf to “1”, and sets the value of the tentative determination flag Xpf to “0”. Thereafter, the CPU proceeds to step 595 to terminate the present routine tentatively.

If the value of the post determination flag Xf is “1” when the CPU proceeds to step 505, the CPU makes a “No” determination at step 505, and proceeds to step 595 to terminate the present routine tentatively.

### <Traveling Control Determination Subroutine>

When the CPU proceeds to step 545 shown in FIG. 5, the CPU starts processing from step 600 shown in FIG. 6, and proceeds to step 605. At step 605, the CPU determines whether or not a present condition is a condition where an abnormal state (failure) that causes the vehicle VA to be unable to travel under one of the traveling controls is not occurring.

When the abnormal state is not occurring in the vehicle VA, the CPU makes a “Yes” determination at step 605, and proceeds to step 610. At step 610, the CPU determines whether or not the above-described autonomous driving condition is satisfied.

When the autonomous driving condition is satisfied, the CPU makes a “Yes” determination at step 610, and proceeds to step 615. At step 615, the CPU sets a value of a first traveling control flag Xtc1 to “1”. Thereafter, the CPU proceeds to step 695 to terminate the present routine tentatively, and proceeds to step 550 shown in FIG. 5. It should be noted that the value of the first traveling control flag Xtc1 is set to “1”, when the autonomous driving control is executed.

Whereas, when the autonomous driving condition is not satisfied, the CPU makes a “No” determination at step 610, and proceeds to step 620. At step 620, the CPU determines whether or not the above-described road shoulder stop condition is satisfied.

When the road shoulder stop condition is satisfied, the CPU makes a “Yes” determination at step 620, and proceeds to step 625. At step 625, the CPU sets a value of a second traveling control flag Xtc2 to “1”. Thereafter, the CPU proceeds to step 695 to terminate the present routine tentatively, and proceeds to step 550 shown in FIG. 5. It should be noted that the value of the second traveling control flag Xtc2 is set to “1”, when the road shoulder stop control is executed.

Whereas, when the road shoulder stop condition is not satisfied, the CPU makes a “No” determination at step 620, and proceeds to step 630. At step 630, the CPU sets a value of a third traveling control flag Xtc3 to “1”. Thereafter, the CPU proceeds to step 695 to terminate the present routine tentatively, and proceeds to step 550 shown in FIG. 5. It should be noted that the value of the third traveling control flag Xtc3 is set to “1”, when the in-lane stop control is executed.

If the abnormal state is occurring in the vehicle VA when the CPU proceeds to step 605, the CPU makes a “No” determination at step 605, and proceeds to step 695 to terminate the present routine tentatively, and proceeds to step 550 shown in FIG. 5. In this case, since none of the first to third traveling control flags Xtc1 to Xtc3 is set to “1”, none of the traveling controls is performed.

### <Return Determination Routine>

The CPU is configured to execute a return determination routine shown by a flowchart in FIG. 7 every time a predetermined time elapses.

When an appropriate time point comes, the CPU starts processing from step 700 in FIG. 7, and proceeds to step 705. At step 705, the CPU determines whether or not one of the values of the tentative determination flag Xpf and the post determination flag Xf is “1”.

When both of the value of the tentative determination flag Xpf and the value of the post determination flag Xf are “0”, the CPU makes a “No” determination at step 705, and proceeds to step 795 to terminate the present routine tentatively.

Whereas, when one of the value of the tentative determination flag Xpf and the value of the post determination flag Xf is “1”, the CPU makes a “Yes” determination at step 705, and sequentially executes the processes of step 710 and step 715.

Step 710: the CPU obtains the face image data from the driver's seat camera 24.

Step 715: the CPU determines whether or not the driver is in an appropriate state based on the face image data.

More specifically, the CPU determines that the driver is in the appropriate state when any of the following states (that are described above) is not detected.

the looking aside state, the eyes closed state, the inappropriate driving posture state, the head lost state, and the drowsy state.

When the driver is not in the appropriate state (in other words, when the driver is in any one of the tentative inappropriate state and the inappropriate state), the CPU makes a “No” determination at step 715, and proceeds to step 720.

The CPU determines whether or not the steering torque Tr is equal to or greater than a predetermined steering torque threshold Trth. The steering torque threshold Trth has been set at a value greater than the steering torque Tr that is generated when the driver holds the steering wheel 52a.

When the steering torque Tr is smaller than the predetermined steering torque threshold Trth, the CPU makes a “No” determination at step 720, and proceeds to step 725. At step 725, the CPU determines whether or not the termination switch 29 is operated.

When the termination switch 29 is not operated, the CPU determines that the above-described return condition is not satisfied. In this case, the CPU makes a “No” determination at step 725, and proceeds to step 730.

At step 730, the CPU determines whether or not the value of the tentative determination flag Xpf is “1”. When the value of the tentative determination flag Xpf is “1”, the CPU makes a “Yes” determination at step 730, and proceeds to step 735. At step 735, the CPU increments the value of the second timer TMb by “1”. Thereafter, the CPU proceeds to step 795 to terminate the present routine tentatively.

When the value of the tentative determination flag Xpf is “0”, the CPU makes a “No” determination at step 730, and proceeds to step 795 to terminate the present routine tentatively.

If the driver is in the appropriate state when the CPU proceeds to step 715, the CPU determines that the return condition is satisfied. In this case, the CPU makes a “Yes” determination at step 715, and proceeds to step 740.

At step 740, the CPU sets both of the value of the tentative determination flag Xpf and the value of the post determination flag Xf to “0”, and sets all of the values of the traveling control flags Xtc1 to Xtc3 to “0”. Thereafter, the CPU proceeds to step 795 to terminate the present routine tentatively.

When the steering torque Tr is equal to or greater than the predetermined steering torque threshold Trth when the CPU proceeds to step 720, the CPU determines that the return condition is satisfied. In this case, the CPU makes a “Yes” determination at step 720, and executes the process of step 740. Thereafter, the CPU proceeds to step 795 to terminate the present routine tentatively.

If the termination switch 29 has been operated before the CPU proceeds to step 725, the CPU determines that the return condition is satisfied. In this case, the CPU makes a “Yes” determination at step 725, and executes the process of step 740. Thereafter, the CPU proceeds to step 795 to terminate the present routine tentatively.

### <Traveling Control Before Final Determination Routine>

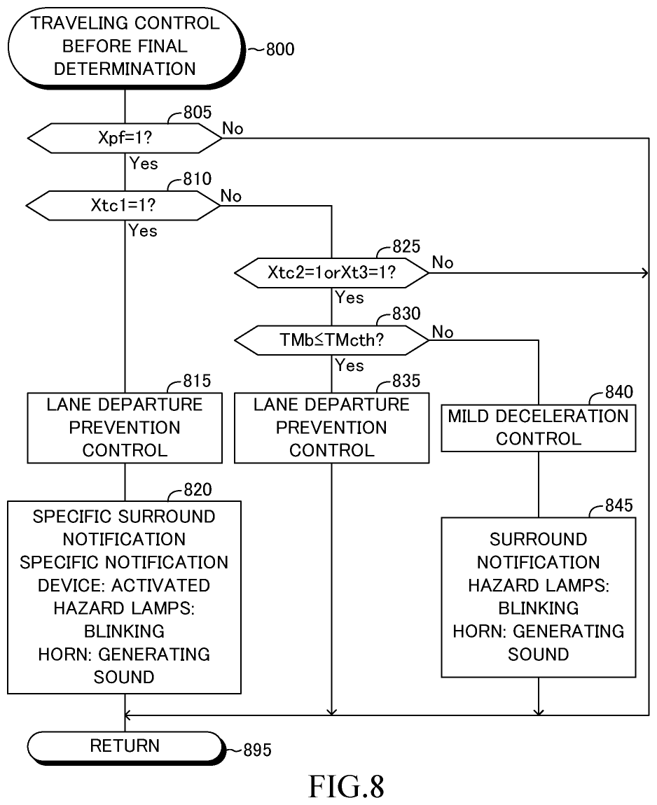

The CPU is configured to execute a traveling control before final determination routine shown by a flowchart in FIG. 8 every time a predetermined time elapses.

When an appropriate time point comes, the CPU starts processing from step 800 in FIG. 8, and proceeds to step 805. At step 805, the CPU determines whether or not the value of the tentative determination flag Xpf is “1”.

When the value of the tentative determination flag Xpf is “0”, the CPU makes a “No” determination at step 805, and proceeds to step 895 to terminate the present routine tentatively.

When the value of the tentative determination flag Xpf is “1”, the CPU makes a “Yes” determination at step 805, and proceeds to step 810. At step 810, the CPU determines whether or not the value of the first traveling control flag Xtc1 is “1”.

When the value of the first traveling control flag Xtc1 is “1”, the CPU makes a “Yes” determination at step 810, and sequentially executes the processes of step 815 and step 820.

Step 815: the CPU performs the above-described lane departure prevention control.

Step 820: the CPU performs the above-described specific surround notification.

Thereafter, the CPU proceeds to step 895 to terminate the present routine tentatively.

Whereas, if the value of the first traveling control flag Xtc1 is “0” when the CPU proceeds to step 810, the CPU makes a “No” determination at step 810, and proceeds to step 825. At step 825, the CPU determines whether or not one of the values of the second traveling control flag Xtc2 and the third traveling control flag Xtc3 is “1”.

When one of the values of the second traveling control flag Xtc2 and the third traveling control flag Xtc3 is “1”, the CPU makes a “Yes” determination at step 825, and proceeds to step 830. At step 830, the CPU determines whether or not the value of the second timer TMb is equal to or smaller than a predetermined third timer threshold TMcth.

The third timer threshold TMcth has been set to a value that the second timer TMb reaches, when the predetermined time t13 elapses from the time point at which the value of the tentative determination flag Xpf is set to “1”. Therefore, the third timer threshold TMcth has been set to the value smaller than the second timer threshold TMbth.

When the value of the second timer TMb is equal to or smaller than the third timer threshold TMcth, the CPU makes a “Yes” determination at step 830, and proceeds to step 835. At step 835, the CPU performs the above-described lane departure prevention control. Thereafter, the CPU proceeds to step 895 to terminate the present routine tentatively.

Whereas, when the value of the second timer TMb is greater than the third timer threshold TMcth, the CPU makes a “No” determination at step 830, and sequentially executes the processes of step 840 and step 845.

Step 840: the CPU performs the above-described mild deceleration control.

Step 845: the CPU performs the above-described surround notification.

Thereafter, the CPU proceeds to step 895 to terminate the present routine tentatively.

When both of the values of the second traveling control flag Xtc2 and the third traveling control flag Xtc3 is “0”, the CPU makes a “No” determination at step 825, and proceeds to step 895 to terminate the present routine tentatively.

<Traveling Control after Final Determination Routine>

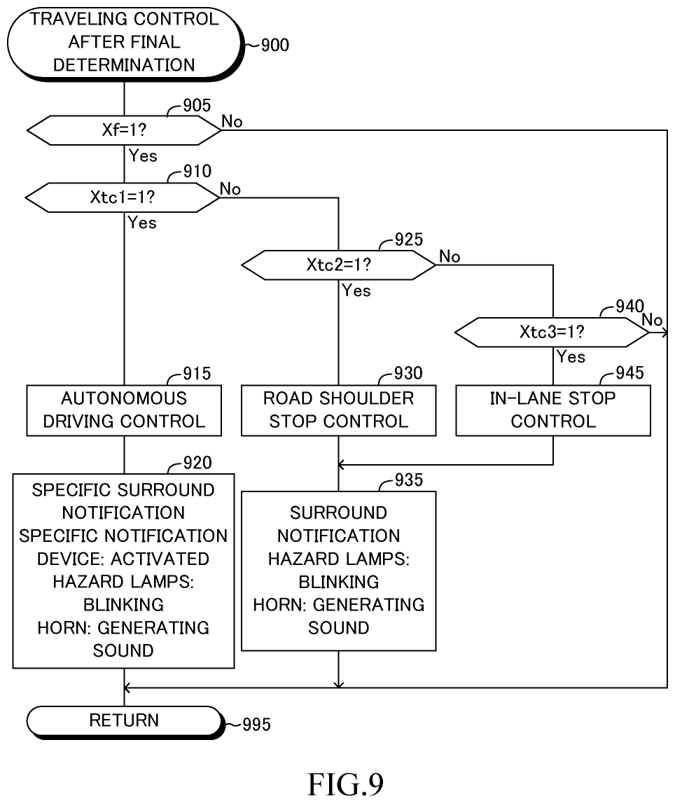

The CPU is configured to execute a traveling control after final determination routine shown by a flowchart in FIG. 9 every time a predetermined time elapses.

When an appropriate time point comes, the CPU starts processing from step 900 in FIG. 9, and proceeds to step 905. At step 905, the CPU determines whether or not the value of the post determination flag Xf is “1”.

When the value of the post determination flag Xf is “0”, the CPU makes a “No” determination at step 905, and proceeds to step 995 to terminate the present routine tentatively.

When the value of the post determination flag Xf is “1”, the CPU makes a “Yes” determination at step 905, and proceeds to step 910. At step 910, the CPU determines whether or not the value of the first traveling control flag Xtc1 is “1”.

When the value of the first traveling control flag Xtc1 is “1”, the CPU makes a “Yes” determination at step 910, and sequentially executes the processes of step 915 and step 920.

Step 915: the CPU performs the above-described autonomous driving control.

More specifically, the CPU obtains a target acceleration Gtgt and a target steering angle θtgt that cause the vehicle VA to travel to the destination along the traveling route. Thereafter, the CPU transmits the acceleration-deceleration instruction including the target acceleration Gtgt to the driving ECU 30 and the brake ECU 40, and transmits the steering instruction including the target steering angle θtgt to the steering ECU 50.

When the driving ECU 30 and the brake ECU 40 receive the acceleration-deceleration instruction, the driving ECU 30 and the brake ECU 40 control the driving source actuator 34 and the brake actuator 44, respectively, so as to cause the acceleration G of the vehicle VA to coincide with the target acceleration Gtgt.

When the steering ECU 50 receives the steering instruction, the steering ECU controls the steering motor 56 so as to cause the steering angle θs to coincide with the target steering angle θtgt.

Step 920: the CPU performs the above-described specific surround notification.

More specifically, the CPU transmits a specific surround notification instruction to the meter ECU 60 and the body ECU 70. When the meter ECU 60 receives the specific surround notification instruction, the meter ECU 60 blinks (all of) the hazard lamps 66. When the body ECU 70 receives the specific surround notification instruction, the body ECU 70 causes the horn 72 to generate the alarm sound, and causes the specific notification device 74 to operate (or to be activated).

Thereafter, the CPU proceeds to step 995 to terminate the present routine tentatively.

Whereas, if the value of the first traveling control flag Xtc1 is “0” when the CPU proceeds to step 910, the CPU makes a “No” determination at step 910, and proceeds to step 925. At step 925, the CPU determines whether or not the value of the second traveling control flag Xtc2 is “1”.

When the value of the second traveling control flag Xtc2 is “1”, the CPU makes a “Yes” determination at step 925, and sequentially executes the processes of step 930 and step 935.

Step 930: the CPU performs the above-described road shoulder stop control.

More specifically, the CPU obtains a target acceleration Gtgt and a target steering angle θtgt that cause the vehicle VA to travel along the traveling path to the target position on the road shoulder RS and to stop at the target position. Thereafter, the CPU transmits the acceleration-deceleration instruction including the target acceleration Gtgt to the driving ECU 30 and the brake ECU 40, and transmits the steering instruction including the target steering angle θtgt to the steering ECU 50.

Step 935: the CPU performs the above-described surround notification.

More specifically, the CPU transmits a surround notification instruction to the meter ECU 60 and the body ECU 70. When the meter ECU 60 receives the surround notification instruction, the meter ECU 60 blinks (all of) the hazard lamps 66. When the body ECU 70 receives the surround notification instruction, the body ECU 70 causes the horn 72 to generate the alarm sound.

Thereafter, the CPU proceeds to step 995 to terminate the present routine tentatively.

Whereas, if the value of the second traveling control flag Xtc2 is “0” when the CPU proceeds to step 925, the CPU makes a “No” determination at step 925, and proceeds to step 940. At step 940, the CPU determines whether or not the value of the third traveling control flag Xtc3 is “1”.

When the value of the third traveling control flag Xt3 is “1”, the CPU makes a “Yes” determination at step 940, and proceeds to step 945. At step 945, the CPU performs the above-described in-lane stop control. More specifically, the CPU obtains a target acceleration Gtgt that cause the vehicle VA to stop, and transmits the acceleration-deceleration instruction including the target acceleration Gtgt to the driving ECU 30 and the brake ECU 40.

Thereafter, the CPU executes the process of step 935, and proceeds to step 995 to terminate the present routine tentatively.

According to the present embodiment, the present control apparatus 10 performs a control that is selected, based on the surrounding of the vehicle VA, from the autonomous driving control, the road shoulder stop control, and the in-lane stop control, when the driver has fallen into the inappropriate state. The present control apparatus 10 performs the specific surround notification when the present control apparatus 10 performs the autonomous driving control. The present control apparatus 10 performs the surround notification when the present control apparatus 10 performs either the road shoulder stop control or the in-lane stop control. Therefore, people outside the vehicle VA can specify (tell) whether or not the vehicle VA is traveling under the autonomous driving control, and can specify (tell) whether or not the vehicle VA is traveling under either the road shoulder stop control or the in-lane stop control. This enhances/increases the possibility that the people can make an appropriate move (take an appropriate action).

The present disclosure should not be limited to the above-described embodiment, and may employ various modifications within the scope of the present disclosure.

### (First Modification)

In the above-described embodiment, the same surround notification (surround notification in the same mode) is performed between when the road shoulder stop control is performed and when the in-lane stop control is performed, however, different surround notifications may be performed therebetween. Namely, the present control apparatus 10 according to a first modification performs a first surround notification when the road shoulder stop control is performed, and performs a second surround notification when the in-lane stop control is performed. For example, a blinking cycle of the hazard lamps 66 in the first surround notification may be longer than a blinking cycle of the hazard lamps 66 in the second surround notification. In other words, the blinking cycle of the hazard lamps 66 in the second surround notification may be shorter than the blinking cycle of the hazard lamps 66 in the first surround notification. In general, people's attention is more easily attracted as a blinking cycle is shorter. Thus, in the first modification, attentions of drivers of the other vehicles can be more easily attracted to the vehicle VA that is under the in-lane stop control. The reason for this configuration is that it is more necessary to draw the driver's attention of the other vehicle to the vehicle VA traveling under the in-lane stop control. since the vehicle VA traveling under the in-lane stop control stops in the traveling lane SL.

Therefore, according to the first modification, since people outside the vehicle VA can specify (tell) whether the vehicle VA is going to stop on the road shoulder RS or in the traveling lane, a possibility that the people can make an appropriate move (take an appropriate action) can be increased.

### (Second Modification)

The present control apparatus 10 according to the above-described embodiment is configured to be able to perform the autonomous driving control, the road shoulder stop control, and the in-lane stop control However, the present control apparatus 10 according to a second modification is configured to be able to perform any two traveling controls out of the autonomous driving control, the road shoulder stop control, and the in-lane stop control.

When the present control apparatus 10 is configured to be able to perform the autonomous driving control and one of “the road shoulder stop control and the in-lane stop control”, the present control apparatus 10 performs the specific surround notification when the present control apparatus 10 performs the autonomous driving control, and performs the surround notification when the present control apparatus 10 performs one of the road shoulder stop control and the in-lane stop control, similarly to the above-described embodiment.

When the present control apparatus 10 is configured to be able to perform the road shoulder stop control and the in-lane stop control only, the present control apparatus 10 performs the first surround notification when the present control apparatus 10 performs the road shoulder stop control, and performs the second surround notification when the present control apparatus 10 performs the in-lane stop control, similarly to the above-described first modification.

In this manner, the present disclosure can be applied to the present control apparatus 10 that is configured to perform at least two of the autonomous driving control, the road shoulder stop control, and the in-lane stop control.

### (Third Modification)

The specific notification device 74 according to a third modification is a display. When the present control apparatus 10 according to the third modification performs the specific surround notification, the apparatus 10 causes the display to display a message stating that “the driver is in the inappropriate state, and the vehicle is traveling under the autonomous driving control to the destination” (to people outside of the vehicle VA).

### (Fourth Modification)

The specific surround notification may be any types of notification as long as the specific surround notification is different from the surround notification. For example, the present control apparatus 10 does not necessarily activate/operate the specific notification device 74 when performing the specific surround notification. In this case, the present control apparatus 10 may blink the hazard lamps 66 at a specific blinking cycle when performing the specific surround notification, the specific blinking cycle being different from the blinking cycle at whch the present control apparatus 10 blinks the hazard lamps 66 when performing the surround notification.

### (Fifth Modification)

In the above-described embodiment, the present control apparatus 10 detects (determines) that the driver is in the inappropriate state, based on the face image data. However, a method to detect (determine) that the driver is in the inappropriate state is not limited to the above embodiment. The present control apparatus 10 according to a fifth modification is configured to detect (determine) that the driver has fallen into the inappropriate state, when it is detected (determined) that a state where the driver does not operate (steer) the steering wheel 52a (namely, a state where the driver lets his/her hands off from the steering wheel 52a) continues for a time equal to or longer than a predetermined time.

For example, the present control apparatus 10 is configured to detect (determine) that the driver has fallen into the inappropriate state, when it is detected (determined) that a state where the steering torque Tr is equal to or smaller than a predetermined no-operation threshold Trth1 continues for a time equal to or longer than a predetermined time.

Furthermore, the present control apparatus 10 may comprise an unillustrated touch sensor that is configured to detect that any of fingers do not touch the steering wheel 52a. In this case, the present control apparatus 10 is configured to detect (determine) that the driver has fallen into the inappropriate state, when it is detected (determined) that a state where the touch sensor detects that any of fingers do not tough the steering wheel 52a continues for a time equal to or longer than a predetermined time.

### (Sixth Modification)

In the above-described embodiment, the present control apparatus 10 starts the specific surround notification or the surround notification before the present control apparatus 10 finally determines (makes a final determination) that the driver has fallen into the inappropriate state. Whereas, the present control apparatus 10 according to a sixth modification starts the specific surround notification or the surround notification when the present control apparatus 10 finally determines (makes a final determination) that the driver has fallen into the inappropriate state.

The present control apparatus 10 according to the sixth modification is configured to prohibit the lane change or the course change until a predetermined time elapses from the time point at which the present control apparatus 10 finally determines (makes a final determination) that the driver has fallen into the inappropriate state, when performing the autonomous driving control or the road shoulder stop control. This assures that the specific surround notification or the surround notification is started before the vehicle VA deviates from the traveling lane SL due to the lane change or the course change. Therefore, the present control apparatus 10 according to the sixth modification can inform people outside of the vehicle VA of a possibility that the vehicle VA deviates from the traveling lane SL with certainty.

### (Seventh Modification)

When the CPU of the VCECU 20 according to a seventh modification starts processing from step 800 in FIG. 8 to start the traveling control before final determination routine, the CPU may determine whether or not the abnormality that causes the vehicle VA to be unable to travel under one of the traveling controls is occurring.

When the above-described abnormality is not occurring, the CPU starts the process of step 805 and processes of steps following step 805. Whereas, when the above-described abnormality is occurring, the CPU proceeds to step 895 to terminate the traveling control before final determination routine tentatively.

In addition, when the CPU according to the seventh modification starts processing from step 900 in FIG. 9 to start the traveling control after final determination routine, the CPU may determine whether or not the above-described abnormality is occurring.

When the above-described abnormality is not occurring, the CPU starts the process of step 905 and processes of steps following step 905. Whereas, when the above-described abnormality is occurring, the CPU proceeds to step 995 to terminate the traveling control after final determination routine tentatively.

### (Eighth Modification)

The present control apparatus 10 may be applied to a vehicle including a vehicle with an internal combustion engine, a hybrid electric vehicle (HEV), a plug-in hybrid electric vehicle (PHEV), a fuel cell electric vehicle (FCEV), and a battery electric vehicle (BEV).

What is claimed is:

1. A vehicle control apparatus comprising:
a control unit that performs a traveling control regarding a travel of a vehicle, when a driver of said vehicle has fallen into an inappropriate state where a condition of said driver is not appropriate for driving said vehicle; and
a notification device that performs a surround notification to notify a person around said vehicle of an execution of said traveling control when said traveling control is performed,
wherein, said control unit is configured to:
be able to perform, as said traveling control, at least two of an in-lane stop control to stop said vehicle in a traveling lane in which said vehicle is traveling, a road shoulder stop control to stop said vehicle on a road shoulder of a road that includes said traveling lane, and an autonomous driving control to autonomously drive said vehicle to a predetermined destination;
perform said traveling control that is selected based on a surrounding of said vehicle from among said in-lane stop control, said road shoulder stop control, and said autonomous driving control, when said driver has fallen into said inappropriate state; and
cause said notification device to perform said surround notification in a mode that varies depending on said traveling control selected to be performed.

2. The vehicle control apparatus according to claim 1,
wherein, said control unit is configured to:
be able to perform at least one of said road shoulder stop control and said autonomous driving control; and
start causing said notification device to perform said surround notification before said vehicle deviates from said traveling lane due to a course change of said vehicle, when performing one of said road shoulder stop control and said autonomous driving control.

3. The vehicle control apparatus according to claim 1,
wherein, said control unit is configured to:
be able to perform said autonomous driving control;
be able to perform at least one of said in-lane stop control and said road shoulder stop control,
wherein, said notification device includes a specific notification device that performs said surround notification of when said autonomous driving control is performed,
and wherein,
said control unit is configured to:
cause said specific notification device to perform said surround notification of when said autonomous driving control is performed, when performing said autonomous driving control, so that a mode of said surround notification of when said autonomous driving control is performed is different from a mode of said surround notification of when said in-lane stop control or said road shoulder stop control is performed.

4. A vehicle control apparatus comprising:
a control unit that performs a traveling control regarding a travel of a vehicle, when a driver of said vehicle has fallen into an inappropriate state where a condition of said driver is not appropriate for driving said vehicle; and
a notification device that performs a surround notification to notify a person outside of said vehicle of an execution of said traveling control when said traveling control is performed,
wherein, said control unit is configured to:
perform, as said traveling control, one of an in-lane stop control to stop said vehicle in a traveling lane in which said vehicle is traveling, a road shoulder stop control to stop said vehicle on a road shoulder of a road that includes said traveling lane, and an autonomous driving control to autonomously drive said vehicle to a predetermined destination, depending on a surrounding of said vehicle, when said driver has fallen into said inappropriate state; and
differentiate a mode of said surround notification of when said autonomous driving control is performed from a mode of said surround notification of when said in-lane stop control or said road shoulder stop control is performed.
